(19) United States
(12) Patent Application Publication
(10) Pub. No.: US 2008/0091909 A1
(43) Pub. Date: Apr. 17, 2008

(54) METHOD AND SYSTEM TO MANAGE VIRTUAL MACHINE MEMORY

(75) Inventor: Jinwoo Hwang, Morrisville, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/548,712

(22) Filed: Oct. 12, 2006

(51) Int. Cl. G06F 12/02

(52) U.S. Cl. 711/170

(57) ABSTRACT

A method to manage memory of a computer system including a virtual machine, is disclosed. The method begins with making available a first segment of a defined amount of memory to the virtual machine and making available a second segment of the defined amount of memory to a heap pool manager. In response to a requirement of at least one of the virtual machine, and the heap pool manager, the method proceeds by determining an amount of memory needed to satisfy the requirement and requesting the amount of memory needed to satisfy the requirement. The method also includes assigning at least one of an unused portion of the first segment, an unused portion of the second segment, and an unused portion of the defined amount of memory to satisfy the requirement.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates to improved memory management and, in particular, to a method and system for optimizing memory management for a virtual machine.

2. Description of Background

In enhancing the performance of a data processing system and the applications executing within the data processing system, it is helpful to know which software modules within a data processing system are using system resources. Effective management and enhancement of data processing systems requires knowing how and when various system resources are being used. Performance tools are used to monitor and examine the data processing system to determine resource consumption as various software applications are executing within the data processing system. For example, a performance tool may identify the most frequently executed modules and instructions in a data processing system, or may identify those modules that allocate the largest amount of memory or perform the most I/O requests. Hardware performance tools may be built into the system or added at a later point in time. Software performance tools also are useful in data processing systems, such as personal computer systems, which typically do not contain many, if any, built-in hardware performance tools.

A runtime statistic that may be analyzed by software developers is memory allocation. A trace tool may log allocation/deallocation requests and the amounts of memory allocated for each memory allocation/deallocation request. Memory allocation information may allow a software developer to analyze memory leakage problems. As an application executes, it stores and retrieves data in a variety of static and dynamic data structures. Statically allocated data structures are declared within the source code, and the compiler allocates storage space for the static data structure. When the application is loaded into memory, the static data structure has a predetermined amount of memory reserved for it, and the application cannot dynamically deallocate this memory.

Other data structures can be dynamically allocated within memory when requested either by the application or by the runtime environment. A portion of memory is dynamically provided for the data structure or data object, and after the application is finished using the data structure, the memory space for the data structure is dynamically deallocated.

Using an object-oriented language such as Java™, available from Sun Microsystems, a Java virtual machine (JVM) may allocate memory from a Java heap, wherein memory heap allocations and deallocations are hidden from the Java programmer. The allocations are performed by the JVM when new objects are specified, such as, “String ABC=“ABC”. The JVM uses the implied new constructor in this case as it allocates the string “ABC”. The deallocations are done by the JVM asynchronously at Garbage collection (GC) time when there are no longer any references to the ABC string; that is, the object is no longer referenced. However, the Java heap is typically statically allocated, and if more Java heap is required than allocated, a Java heap exhaustion will occur, and execution of the application will be interrupted.

Accordingly, there is a need in the art for a Java heap management arrangement that overcomes these drawbacks.

### SUMMARY OF THE INVENTION

The shortcomings of the prior art are overcome and additional advantages are provided through the provision of a method and system for allocating additional Java heap to JVMs.

An embodiment of the invention includes a method to manage memory of a computer system including a virtual machine. The method begins with making available a first segment of a defined amount of memory to the virtual machine and making available a second segment of the defined amount of memory to a heap pool manager. In response to a requirement of at least one of the virtual machine, and the heap pool manager, the method proceeds by determining an amount of memory needed to satisfy the requirement and requesting the amount of memory needed to satisfy the requirement. The method also includes assigning at least one of an unused portion of the first segment, an unused portion of the second segment, and an unused portion of the defined amount of memory to satisfy the requirement.

Another embodiment of the invention includes a method to manage memory of a computer system comprising a virtual machine. The method begins with making available a first segment of a defined amount of memory to the virtual machine, and making available a second segment of the defined amount of memory to a first heap pool manager. The method further includes determining an amount of memory in excess of the first segment needed to satisfy a requirement of the virtual machine and requesting from the first heap pool manager the amount of memory in excess of the first segment to satisfy the requirement of the virtual machine. The method includes assigning to the virtual machine an unused portion of the second segment.

Subsequent to a lack of response by the first heap pool manager to the request by the virtual machine, the method proceeds by making available to a secondary heap pool manager at least one of an identification of the virtual machine, an allocated address range of the second segment, and a timestamp of allocation of the second segment. The method continues by requesting from the secondary heap pool manager the amount of memory to satisfy the requirement of the virtual machine, determining a status of the first heap pool manager; and in response to a non-functioning status, assigning, by the secondary heap pool manager, to the virtual machine the unused portion of the second segment to satisfy the requirement of the virtual machine.

Further, the method includes determining an amount of memory in excess of the second segment needed to satisfy a requirement of one of the first heap pool manager, and the secondary heap pool manager, requesting from the computer system the amount of memory to satisfy the requirement of one of the first heap pool manager, and the secondary heap pool manager and assigning to one of the first heap pool manager and the secondary heap pool manager an unused portion of the defined amount of memory to satisfy the requirement of one of the first heap pool manager, and the secondary heap pool manager.

The method further includes determining if a requirement of the virtual machine is less than the first segment. In response to determining that the requirement of the virtual machine is less than the first segment, assigning to one of the first heap pool manager, and the secondary heap pool manager an amount of memory assigned to the virtual machine in excess of the first segment. Additionally, determining if a requirement of one of the first heap pool manager, and the secondary heap pool manager is less than the second segment; and in response to determining that the requirement of one of the first heap pool manager and the secondary heap pool manager is less than the second segment of memory, assigning to the computer system an amount of memory assigned to one of the first heap manager, and the secondary heap pool manager in excess of the second segment.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which will provide an arrangement to manage Java heap memory. A Java heap pool manager will allocate additional heap memory to JVMs that need more heap memory and deallocate heap memory where appropriate to maximize utilization of system resources. This will result in a reduced likelihood of heap exhaustion errors that lead to service interruptions, and thereby allow for increased efficiency of use of Java heap across multiple Java processes.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a distributed data processing system in which the present invention may be implemented.

FIGS. 2A and 2B illustrate examples of block diagrams depicting a data processing system in which the present invention may be implemented.

FIG. 3A illustrates one example of a block diagram depicting the relationship of software components operating within a computer system that may implement the present invention.

FIG. 3B illustrates one example of a block diagram depicting a Java virtual machine in accordance with an embodiment of the present invention.

FIG. 4 illustrates one example of a flowchart of a method to manage memory in accordance with an embodiment of the present invention.

The detailed description explains the preferred embodiments of the invention, together with advantages and features, by way of example with reference to the drawings.

### DETAILED DESCRIPTION OF THE INVENTION

An embodiment of the invention will provide a Java heap pool manager, which is a separate process to allocate Java heap memory to a set of client JVMs. In an embodiment of the invention, the heap pool manager will control allocation of heap memory to each JVM of the set of JVMs. In response to a likely exhaustion of a Java heap, the JVM will request more heap memory from the heap pool manager, which will allocate the additional heap memory to the JVM. In an embodiment, primary and backup heap pool managers will be used to provide a fail-safe arrangement in the event of a failure of the primary heap pool manager.

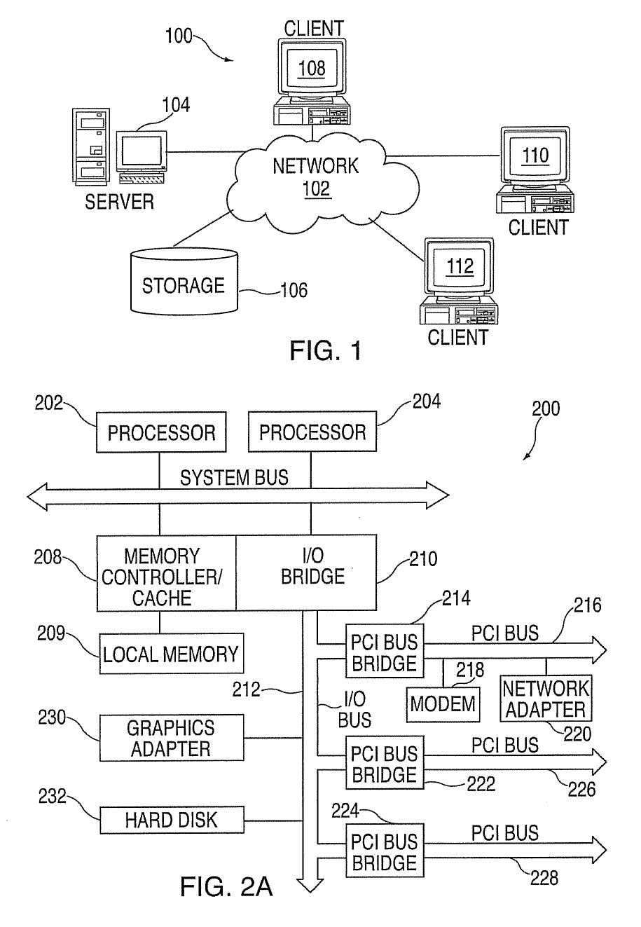

With reference now to the figures, and in particular with reference to FIG. 1, a pictorial representation of a distributed data processing system in which the present invention may be implemented is depicted.

Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections.

In the depicted example, a server 104 is connected to network 102 along with a storage unit 106. In addition, clients 108, 110, and 112 also are connected to the network 102. These clients 108, 110, and 112 may be, for example, personal computers or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Of course, distributed data processing system 100 also may be implemented as a number of different types of networks, such as, for example, an Intranet or a local area network.

FIG. 1 is intended as an example, and not as an architectural limitation for the processes of the present invention.

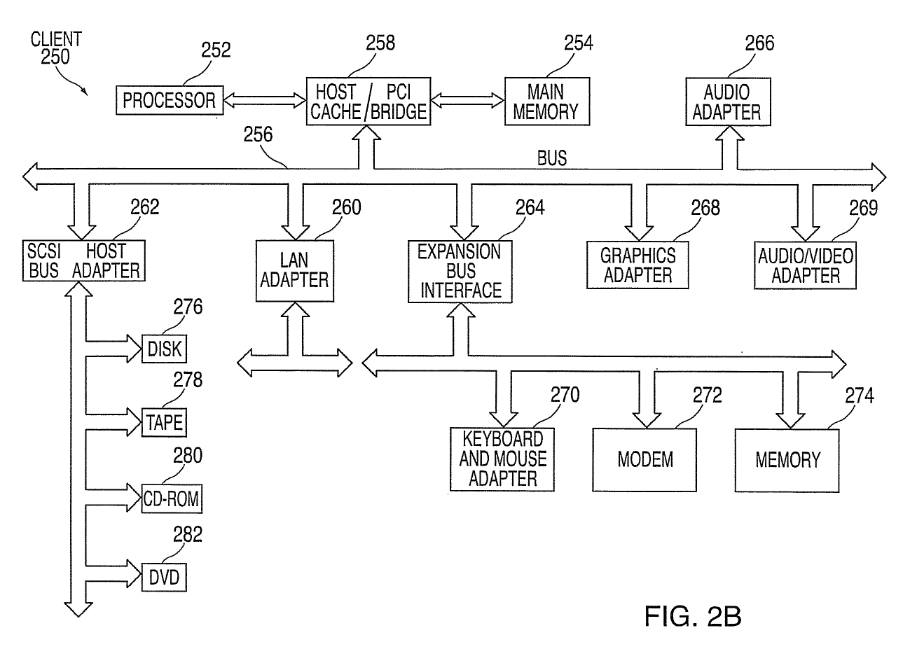

With reference now to FIG. 2A, a block diagram of a data processing system 200, which may be implemented as a server, such as server 104 in FIG. 1, is depicted in accordance to the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214, connected to I/O bus 212 provides an interface to PCI local bus 216. A modem 218 may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and a program storage device, also herein referred to as a hard disk 232 may also be connected to I/O bus 212 as depicted, either directly or indirectly.

Those of ordinary skill in the art will appreciate that the hardware depicted in FIG. 2A may vary. For example, other peripheral devices, such as optical disk drives and the like also may be used in addition or in place of the hardware depicted. The depicted example is not meant to imply architectural limitations with respect to the present invention.

The data processing system depicted in FIG. 2A may be, for example, an IBM RISC/System 6000 system, a product of International Business Machines Corporation in Armonk, N.Y., running the Advanced Interactive Executive (AIX) operating system.

With reference now to FIG. 2B, a block diagram of a data processing system in which the present invention may be implemented is illustrated. Data processing system 250 is an example of a client computer. Data processing system 250 employs a peripheral component interconnect (PCI) local bus architecture. Although the depicted example employs a PCI bus, other bus architectures such as Micro Channel and Industry Standard Architecture (ISA), for example, may be used. Processor 252 and main memory 254 are connected to PCI local bus 256 through PCI Bridge 258. PCI Bridge 258 also may include an integrated memory controller and cache memory for processor 252. Additional connections to PCI local bus 256 may be made through direct component interconnection or through add-in boards. In the depicted example, local area network (LAN) adapter 260, SCSI host bus adapter 262, and expansion bus interface 264 are connected to PCI local bus 256 by direct component connection. In contrast, audio adapter 266, graphics adapter 268, and audio/video adapter (A/V) 269 are connected to PCI local bus 266 by add-in boards inserted into expansion slots. Expansion bus interface 264 provides a connection for a keyboard and mouse adapter 270, modem 272, and additional memory 274. SCSI host bus adapter 262 provides a connection for hard disk drive 276, tape drive 278, CD-ROM 280, and DVD drive 282 in the depicted example. Typical PCI local bus implementations will support three or four PCI expansion slots or add-in connectors.

An operating system runs on processor 252 and is used to coordinate and provide control of various components within data processing system 250 in FIG. 2B. The operating system may be a commercially available operating system such as JavaOS for Business™ or OS/2™, which are available from International Business Machines Corporations™. JavaOS is loaded from a server on a network to a network client and supports Java programs and applets. An object oriented programming system such as Java may run in conjunction with the operating system and may provide calls to the operating system from Java programs or applications executing on data processing system 250. Instructions for the operating system, the object-oriented operating system, and applications or programs are located on storage devices, such as hard disk drive 276 and may be loaded into main memory 254 for execution by processor 252. Hard disk drives are often absent and memory is constrained when data processing system 250 is used as a network client.

Those of ordinary skill in the art will appreciate that the hardware in FIG. 2B may vary depending on the implementation. For example, other peripheral devices, such as optical disk drives and the like may be used in addition to or in place of the hardware depicted in FIG. 2B. The depicted example is not meant to imply architectural limitations with respect to the present invention. For example, the processes of the present invention may be applied to a multiprocessor data processing system.

The present invention provides a process and system for optimizing software performance via management of JVM heap memory. Although the present invention may operate on a variety of computer platforms and operating systems, it may also operate within a Java runtime environment. Hence, the present invention may operate in conjunction with a JVM yet within the boundaries of the JVM as defined by Java standard specifications. In order to provide a context for the present invention, portions of the operation of the JVM according to Java specifications are herein described.

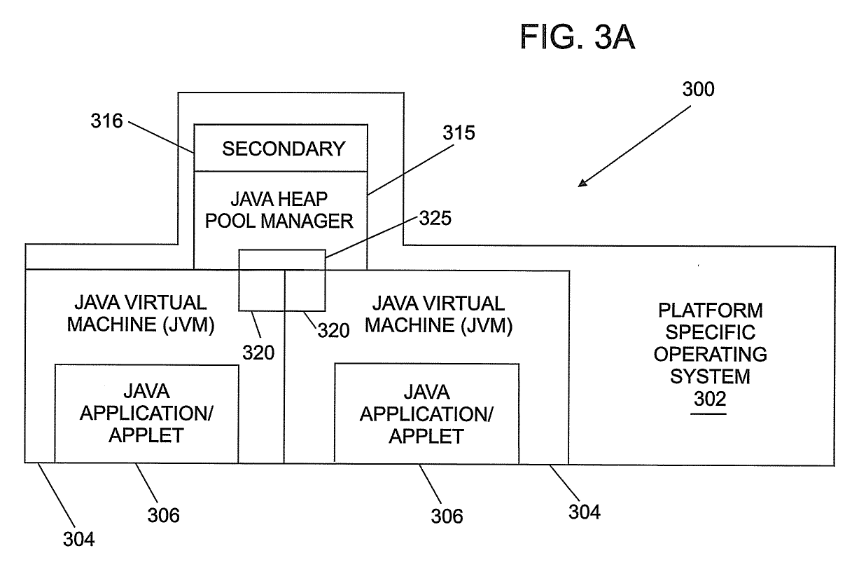

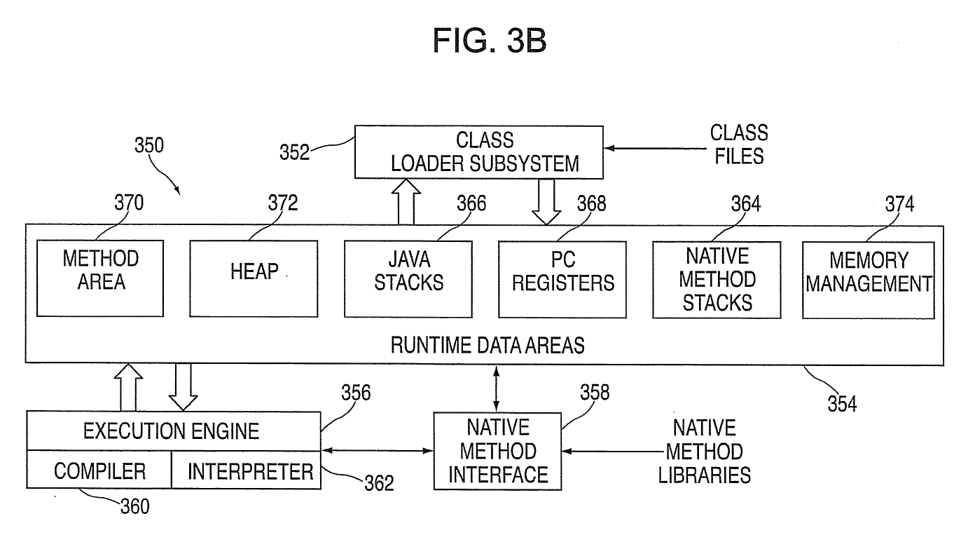

With reference now to FIG. 3A, a block diagram of a Java heap memory management system 300, operating within a computer system, is depicted. The Java heap memory management system 300 contains a platform specific operating system 302 that provides hardware and system support to software executing on a specific hardware platform. A set of JVMs 304 is a set of software applications that may execute in conjunction with the operating system 302. JVMs 304 provide the Java run-time environment with the ability to execute a set of Java applications or applets 306 which are programs, servlets, or software components written in the Java programming language. The computer system in which JvMs 304 operate may be similar to data processing system 200 or 250 described above. However, JVMs 304 may also be implemented in dedicated hardware on a so-called Java chip, Java-on-silicon, or Java processor with an embedded picoJava core. In an embodiment, a Java heap pool manager (also herein referred to as a first heap pool manager) 315 will dynamically, on demand, allocate heap memory between each of the JVMs 304, as will be discussed further below. The Java heap pool manager 315 will also dynamically, on demand, allocate operating system 302 memory, such as computer system memory 209, 274 described above, for use as heap memory and deallocate, or return, unneeded heap memory back to the operating system 302 for alternate use as required by the computer system 200, 250. A secondary Java heap pool manager (also herein referred to as a secondary heap pool manager) 316 can be used if the Java heap pool manager 315 fails to respond to a request by one of the JVMs 304.

At the center of a Java run-time environment is the JVM, which supports all aspects of Java's environment, including its architecture, security features, mobility across networks, and platform independence.

The JVM is a virtual computer, i.e. a computer that is specified abstractly. The specification defines certain features that every JVM must implement, with some range of design choices that may depend upon the platform on which the JVM is designed to execute. For example, all JVMs must execute Java bytecodes and may use a range of techniques to execute the instructions represented by the bytecodes. A JVM may be implemented completely in software or somewhat in hardware. This flexibility allows different JVMs to be designed for mainframe computers and personal digital assistants (PDA)s, for example.

The JVM is the name of the virtual computer component that actually executes Java programs. Java programs are not run directly by the central processor but instead by the JVM, which is itself a piece of software running on the processor. The JVM allows Java programs to be executed on different platforms, as opposed to only the one platform for which the code was compiled. Java programs are compiled for the JVM. In this manner, Java is able to support applications for many types of data processing systems, which may contain a variety of central processing units and operating system architectures. To enable a Java application to execute on different types of data processing systems, a compiler typically generates an architecture-neutral file format, that is, the compiled code is executable on many processors, given the presence of the Java run-time system. The Java compiler generates bytecode instructions that are nonspecific to a particular computer architecture. A bytecode is a machine independent code generated by the Java compiler and executed by a Java interpreter. A Java interpreter is part of the JVM that alternately decodes and interprets a bytecode or bytecodes. These bytecode instructions are designed to be easy to interpret on any computer and easily translated on the fly into native machine code. Byte codes may be translated into native code by a just-in-time compiler or JIT.

A JVM must load class files and execute the bytecodes within them. The JVM contains a class loader, which loads class files from an application and the class files from the Java application programming interfaces (APIs), which are needed, by the application. The execution engine that executes the bytecodes may vary across platforms and implementations.

One type of software-based execution engine is a just-in-time compiler. With this type of execution, the bytecodes of a method are compiled to native machine code upon successful fulfillment of some type of criteria for just-in-time compiling a method. The native machine code for the method is then cached and reused upon the next invocation of the method. The execution engine may also be implemented in hardware and embedded on a chip so that the Java bytecodes are executed natively. JVMs usually interpret bytecodes, but JVMs may also use other techniques, such as just-in-time compiling, to execute bytecodes.

Interpreting code provides an additional benefit. Rather than instrumenting the Java source code, the interpreter may be instrumented. Trace data may be generated via selected events and timers through the instrumented interpreter without modifying the source code.

When an application is executed on a JVM that is implemented in software on a platform-specific operating system, a Java application may interact with the host operating system by invoking native methods. A Java method is written in the Java language, compiled to bytecodes, and stored in class files. A native method is written in some other language and compiled to the native machine code of a particular processor. Native methods are stored in a dynamically linked library whose exact form is platform specific.

With reference now to FIG. 3B, a block diagram of a JVM 350 is depicted in accordance with a preferred embodiment of the present invention. JVM 350 includes a class loader subsystem 352, which is a mechanism for loading types, such as classes and interfaces, given fully qualified names. JVM 350 also contains runtime data areas 354, execution engine 356, native method interface 358, and memory management 374. Execution engine 356 is a mechanism for executing instructions contained in the methods of classes loaded by class loader subsystem 352. Execution engine 356 may be, for example, Java interpreter 362 or just-in-time compiler 360. Native method interface 358 allows access to resources in the underlying operating system. Native method interface 358 may be, for example, a Java native interface.

Runtime data areas 354 contain native method stacks 364, Java stacks 366, PC registers 368, method area 370, and heap 372. These different data areas represent the organization of memory needed by JVM 350 to execute a program.

Java stacks 366 are used to store the state of Java method invocations. When a new thread is launched, the JVM 350 creates a new Java stack for the thread. The JVM 350 performs only two operations directly on Java stacks 366: it pushes and pops frames. A thread's Java stack stores the state of Java method invocations for the thread. The state of a Java method invocation includes its local variables, the parameters with which it was invoked, its return value, if any, and intermediate calculations. Java stacks are composed of stack frames. A stack frame contains the state of a single Java method invocation. When a thread invokes a method, the JVM pushes a new frame onto the Java stack of the thread. When the method completes, the JVM pops the frame for that method and discards it. The JVM does not have any registers for holding intermediate values; any Java instruction that requires or produces an intermediate value uses the stack for holding the intermediate values. In this manner, the Java instruction set is well defined for a variety of platform architectures.

PC registers 368 are used to indicate the next instruction to be executed. Each instantiated thread gets its own PC register (program counter) and Java stack. If the thread is executing a JVM method, the value of the PC register indicates the next instruction to execute. If the thread is executing a native method, then the contents of the PC register are undefined.

Native method stacks 364 store the state of invocations of native methods. The state of native method invocations is stored in an implementation-dependent way in native method stacks, registers, or other implementation-dependent memory areas. In some JVM implementations, native method stacks 364 and Java stacks 366 are combined.

Method area 370 contains class data while heap 372 contains all instantiated objects. The JVM specification strictly defines data types and operations. Most JvMs 350 choose to have one method area and one heap, each of which is shared by all threads running inside the JVM 350. When the JVM 350 loads a class file, it parses information about a type from the binary data contained in the class file. It places this type information into the method area 370. Each time a class instance or array is created, the memory for the new object is allocated from heap 372. JVM 350 includes an instruction that allocates memory space within the memory for heap 372 but includes no instruction for freeing that space within the memory. Memory management 374 in the depicted example manages memory space within the memory allocated to heap 370. Memory management 374 may include a Garbage Collector, which automatically reclaims memory used by objects that are no longer referenced. Additionally, a Garbage Collector also may move objects to reduce heap fragmentation.

The nature of the JVM 350 is that each allocation of memory is specified to be a contiguous section of memory. Accordingly, any fragmentation of the heap 372 will result in reduced performance of the JVM 350, and may lead to a heap exhaustion, which is an attempt to use more heap memory than is available to the JVM 304, 312. Heap exhaustion will interrupt the service of any Java Application 306 running on any JVM 304, 312 of the set of Ms.

With reference now to FIGS. 2A, 2B, and 3A, an embodiment of the Java heap memory management system 300 includes the computer system, also herein referred to as the data processing system, 200, 250, system memory 209, 274, and a set of Java virtual machines 304 configured to execute applications 306, or programs. In an embodiment, the system memory is a defined amount of memory. In an embodiment, the defined amount of memory is an amount of memory defined by a singular memory element, such as Random Access Memory elements, for example. In another embodiment, the defined amount of memory is an amount of memory defined by a collective grouping of memory elements, such as Random Access Memory elements, for example. The JVMs 304 each include a first segment 320 of the defined amount of memory 209, 274 assigned, or made available to each virtual machine 304 as heap memory. In an embodiment, the set of virtual machines 304 is one virtual machine 304.

While an embodiment of the invention is described and depicted showing two Java virtual machines, it will be appreciated that the scope of the invention is not so limited, and that the invention will also apply to computer systems that may have other numbers of Java virtual machines, such as one, three, four, or more Java virtual machines, for example. Further while an embodiment of the invention is described having Java virtual machines, it will be appreciated that the scope of the invention is not so limited, and that the invention will also apply to other computer systems that may have other software virtual computers running programs.

In an embodiment, the heap pool manager 315 is configured to manage assignment of the defined amount of memory 209, 274 for each virtual machine 304. A second segment 325 of the defined amount of memory 209, 274 is assigned, or made available to the heap pool manager 315 as heap memory. In response to a requirement for more heap memory 320, 325 of at least one of any of the set of virtual machines 304, and the heap pool manager 315, at least one of the heap pool manager 315, and any respective virtual machine 304 of the set of virtual machines 304 are configured to determine an amount of memory that is necessary to satisfy the requirement, and thereby reduce the likelihood of an occurrence of heap exhaustion. At least one of any of the set of virtual machines 304, and the heap pool manager 315 is configured to request the amount of memory needed to satisfy the requirement and therefore reduce the probability of heap exhaustion. To fulfill, or satisfy the request, at least one of any respective virtual machine 304, and the heap pool manager 315 is configured to assign at least one of an unused portion of the first segment 320, an unused portion of the second segment 325, and an unused portion of the defined amount of memory 209, 274 to satisfy the requirement, and reduce the possibility of heap exhaustion.

In an embodiment, any of the set of virtual machines 304 is configured to determine an amount of memory in excess of the first segment 320 needed to satisfy the requirement of any of the respective virtual machines 304 necessary to reduce the possibility of heap exhaustion. In an embodiment, any virtual machine 304 that requires heap memory is configured to request the amount of heap memory required to reduce the possibility of heap exhaustion from the heap pool manager 315. In an embodiment, the heap pool manager 315 is configured to assign to the appropriate virtual machine 304 the unused portion of the second segment 325 to satisfy the requirement of heap memory.

In an embodiment, the secondary heap pool manager 316 is included to provide a back up in the event of a failure of the heap pool manager 315 to function as expected. In an embodiment, subsequent to a lack of response by the heap pool manager 315, any virtual machine 304 is configured to request the required amount of heap memory from the secondary heap pool manager 316 to avoid heap exhaustion. The secondary heap pool manager 316 is configured to be responsive to the request from the virtual machine 304 for the required amount of memory to reduce the likelihood of heap exhaustion. In an embodiment, following the request by any virtual machine 304, the secondary heap pool manager 316 is configured to obtain information associated with the heap pool manager 315, in order to allow for a seamless transition of control to the secondary heap pool manager 316 from the Java heap pool manager 315. In an embodiment, the secondary heap pool manager 316 is configured to obtain at least one of an identification of each virtual machine 304 of the set of virtual machines 304, an allocated address range of the second segment 325 of heap memory, and a timestamp of allocation of the second segment 325 of heap memory. In an embodiment, the secondary heap pool manager 316 is configured to determine a status of the heap pool manager 315. In response to a non-functioning status of the Java heap pool manager 315, the secondary heap pool manager is configured to assign to any of the set of virtual machines 304 the unused portion of the second segment 325 of heap memory to satisfy the requirement to reduce the likelihood of heap exhaustion.

While an embodiment of the invention has been described having one secondary heap pool manager to act as a back up in the event of failure of the heap pool manager, it will be appreciated that the scope of the invention is not so limited, and that the invention will also apply to heap memory management systems 300 that may have more than one secondary heap pool manager to act as a back up in the event of failure of the secondary heap pool manager, such as two, three, four, or more secondary heap pool managers, for example.

In an embodiment, the heap pool manager 315 is configured to determine if there is sufficient heap memory available within the second segment 325 of heap memory to support any request for heap memory by any of the set of virtual machines 304. In an embodiment, the heap pool manager 315 is configured to determine an amount of memory in excess of the second segment 325 of heap memory needed to satisfy the requirement of the heap pool manager 315, as may be needed to be assigned to any of the set of virtual machines 304. In an embodiment, the heap pool manager 315 is configured to request from the computer operating system 302 the amount of memory 209, 274 to satisfy the requirement of the heap pool manager 315 and to assign the unused portion of the defined amount of memory 209, 274 to satisfy the request of the heap pool manager 315.

In an embodiment, each virtual machine 304 is configured to release any unneeded heap memory to the heap pool manager 315 so that it may be used appropriately, such as for any other of the set of virtual machines 304. In an embodiment, each virtual machine 304 is configured to determine if a requirement of memory by the virtual machine 304 is less than the first segment 320of heap memory. In an embodiment, in response to the determination that the requirement by the virtual machine 304 is less than the first segment 320 of heap memory made available to the virtual machine 304, the virtual machine 304 is configured to assign to the heap pool manager 315 an amount of memory assigned to the virtual machine 304 in excess of the requirement. In an embodiment, each virtual machine 304 is configured to assign to the heap pool manager 315 an amount of memory assigned to the virtual machine 304 in excess of the first segment 320 of heap memory. In an alternate embodiment, the heap pool manager 315 is configured to determine if the requirement of memory of each virtual machine 304 is less than first segment 320 of heap memory. In an embodiment, the heap pool manager 315 is configured to assign to the heap pool manager 315 the amount of memory assigned to the virtual machine 304 in excess of the requirement.

In an embodiment, the heap pool manager 315 is configured to release any unneeded heap memory from the from the heap pool manager 315 to the computer operating system 302 such that system memory 209, 274 may be used appropriately, such as for any other resource of the computer 200, 250 that may utilize the system memory 209, 274. In an embodiment, the heap pool manager 315 is configured to determine if a requirement by the heap pool manager 315 for heap memory is less than the second segment 325 of heap memory made available to the heap pool manager 315. In an embodiment, in response to the determination that the requirement by the heap pool manager 315 for heap memory is less than the second segment 325 of heap memory, the heap pool manager 315 is configured to assign to the operating system 302 of the computer 200, 250 an amount of heap memory assigned to the heap pool manager 315 in excess of the requirement by the heap pool manager 315. In an embodiment, the heap pool manager is configured to assign to the operating system 302 of the computer 200, 250 an amount of heap memory assigned to the heap pool manager 315 in excess of the second segment 325 of heap memory.

An illustrative example follows, assuming a computer system 200, 250 with a defined amount of seven gigabytes (GB) of system memory 209, 274. Each of two JVMs 304 are assigned as the first segment 320 one GB of Java heap memory. Additionally, the Java heap pool manager 315 is assigned as the second segment 325 two GBs of Java heap memory. Although workload balanced incoming requests may be used to attempt maintenance of equal heap memory requirements by each JVM 304, the actual Java heap memory requirement may differ between the two JVMs 304.

In response to an impending shortage of local Java heap in a first JVM 304, the first JVM 304 sends a request to the Java heap pool manager 315 for more Java heap memory. Accordingly, the Java heap pool manager 315 assigns, or allocates 500 megabytes (MB) to the first JVM 304. Subsequently, a second JVM 304 determines an impending shortage of local Java heap, and sends a request to the Java heap pool manager to get 500 MB more of Java heap memory. Accordingly, the Java heap pool manager 315 assigns, or allocates 500 MB to the second JVM 304. A second impending shortage of local Java heap in the first JVM 304 results in another request by, and assignment to, the first JVM 304 for additional Java heap memory.

Some time later, the Java heap usage on the second JVM 304 is decreased, and the second JVM 304 returns to the Java heap pool manager 315 some or all of the unneeded Java heap that was assigned to the second JVM 304 by the Java heap pool manager 315. Subsequently, the Java heap usage on the first JVM 304 is decreased, and the first JVM 304 returns to the Java heap pool manager 315 some or all of the unneeded Java heap that was assigned to the first JVM 304 by the Java heap pool manager 315.

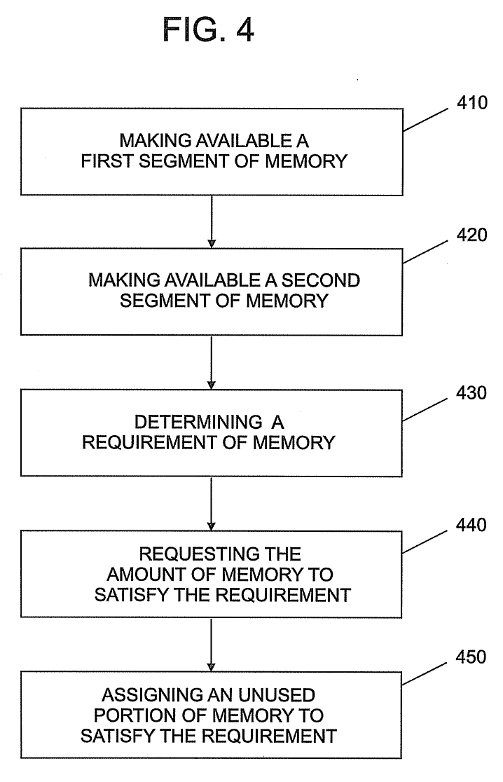

In view of the foregoing, the heap memory management system 300 performs the method of managing memory. Referring now to FIG. 4, a flowchart 400 of an exemplary method of managing memory is depicted.

In an embodiment, the method begins with making available 410 the first segment 320 of the defined amount of memory as heap memory to each virtual machine 304 of the set of virtual machines and making available 420 the second segment 325 of the defined amount of memory as heap memory to the heap pool manager 315. In response to the requirement of at least one of any virtual machine 304 of the set of virtual machines 304, and the heap pool manager 315, the method proceeds with determining 430 the amount of memory needed to satisfy the requirement, requesting 440 the amount of memory needed to satisfy the requirement, and assigning 450 at least one of the unused portion of the first segment 320of heap memory, the unused portion of the second segment 325of heap memory, and the unused portion of the defined amount of computer system memory 209, 274 to satisfy the requirement. In an embodiment, the making available 410 the first segment 320 of heap memory includes making available 410 the first segment of heap memory 320 having the same amount of memory to each virtual machine 304 of the set of virtual machines 304. In an embodiment, the making available the first segment of the defined amount of memory includes making available the first segment of the defined amount of memory 320 to one virtual machine 304.

In an embodiment, the determining 430 the amount of memory includes determining 430 the amount of memory in excess of the first segment 320 of heap memory needed to satisfy the requirement of any virtual machine 304 of the set of virtual machines 304. In an embodiment, the requesting 440 the amount of memory includes requesting from the heap pool manager 315 the amount of memory to satisfy the requirement of the respective virtual machine 304. In an embodiment, the assigning 450 includes assigning 450 to the virtual machine 304 the unused portion of the second segment 325 of heap memory requested to satisfy the requirement.

In an embodiment, subsequent to a lack of response by the heap pool manager 315 to the request by any virtual machine 304 of the set of virtual machines 304, the method further includes the use of the secondary heap pool manager 316 as a back up to the heap pool manager 315. In an embodiment, using the secondary heap pool manager 316 as a back up includes making available to the secondary heap pool manager 316 information associated with the heap pool manager 315 to allow access by the secondary heap pool manager 316 to the second segment 325 of heap memory. Use of the secondary heap pool manager 316 also includes requesting from the secondary heap pool manager 316 the amount of memory, needed to satisfy the requirement of the respective virtual machine 304, and determining the status of the heap pool manager 315. In response to a non-functioning status of the heap pool manager 315, assigning, by the secondary heap pool manager 316, to the appropriate virtual machine 304, the unused portion of the second segment 325 of heap memory to satisfy the requirement. In an embodiment, the making available information associated with the heap pool manager 315 includes making available to the secondary heap pool manager 316 at least one of the identification of each virtual machine 304 of the set of virtual machines 304, the allocated address range of the second segment 325 of heap memory, and the timestamp of allocation of the second segment 325of heap memory.

In an embodiment, the determining 430 the amount of memory includes determining 430 an amount of memory in excess of the second segment 325 of heap memory needed to satisfy the requirement of the heap pool manager 315, such as to fulfill a request for memory by any of the set of virtual machines 304, for example. In an embodiment, the requesting 440 the amount of memory includes requesting 440 the amount of computer system memory 209, 274 by the heap pool manager 315 from the operating system 302. In an embodiment, the assigning 450 includes assigning 450 to the heap pool manager 315 the unused portion of remaining computer system memory 209, 274 to satisfy the requirement of the heap pool manager 315.

In an embodiment, the method further includes releasing any unneeded memory from any virtual machine 304 to the heap pool manager 315. The releasing unneeded memory includes determining if a requirement by any virtual machine 304 of the set of virtual machines 304 for heap memory is less than the first segment of heap memory 320 made available to the respective virtual machine 304. In response to determining that the requirement by any virtual machine 304 of the set of virtual machines 304 for heap memory is less than the first segment of heap memory 320, assigning to the heap pool manager 315 an amount of memory assigned in excess of the requirement. In an embodiment, the assigning to the heap pool manager 315 includes assigning to the heap pool manager 315 the amount of memory assigned to any virtual machine 304 of the set of virtual machines 304 in excess of the first segment of heap memory 320.

In an embodiment, the method further includes releasing any unneeded memory from the heap pool manager 315 to the operating system 302 for use as computer system memory 209, 274. The releasing any unneeded memory from the heap pool manager 315 includes by determining if the requirement by the heap pool manager 315 for memory is less than the second segment 325 of heap memory. In response to determining that the requirement by the heap pool manager 315 for memory is less than the second segment of heap memory 325, assigning to the computer operating system 302 the amount of memory assigned to the heap pool manager 315 in excess of the requirement by the heap pool manager 315. In an embodiment, the assigning to the computer operating system 302 includes assigning to the computer operating system 302 an amount of memory assigned to the heap pool manager 315 in excess of the second segment 325 of heap memory.

As disclosed, some embodiments of the invention may include some of the following advantages: Minimizing service interruption of JVMs caused by heap exhaustion; efficient use of system resources by allocating heap memory across multiple JVMs; increased stability and availability of the JVMs by reducing heap exhaustion; and the ability for a single Java heap pool manager to perform garbage collection in parallel with multiple JVMs.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

While the preferred embodiment to the invention has been described, it will be understood that those skilled in the art, both now and in the future, may male various improvements and enhancements which fall within the scope of the claims which follow. These claims should be construed to maintain the proper protection for the invention first described.

What is claimed is:

1. A method to manage memory of a computer system comprising a virtual machine, the method comprising:
making available a first segment of a defined amount of memory to the virtual machine;
making available a second segment of the defined amount of memory to a heap pool manager;
in response to a requirement of at least one of the virtual machine, and the heap pool manager, determining an amount of memory needed to satisfy the requirement;
requesting the amount of memory needed to satisfy the requirement; and
assigning at least one of an unused portion of the first segment, an unused portion of the second segment, and an unused portion of the defined amount of memory to satisfy the requirement.

2. The method of claim 1, wherein the making available the first segment comprises:
making available the first segment of the defined amount of memory to a single virtual machine.

3. The method of claim 1, wherein:
the determining the amount of memory comprises determining an amount of memory in excess of the first segment needed to satisfy the requirement of the virtual machine; and
the requesting the amount of memory comprises requesting the amount of memory to satisfy the requirement of the virtual machine.

4. The method of claim 3, wherein the assigning comprises:
assigning to the virtual machine the unused portion of the second segment requested to satisfy the requirement.

5. The method of claim 3, wherein the heap pool manager is a first heap pool manager, and subsequent to a lack of response by the first heap pool manager to the request by the virtual machine, the method further comprising:
making available to a secondary heap pool manager information associated with the first heap pool manager;
requesting from the secondary heap pool manager the amount of memory to satisfy the requirement;
determining a status of the first heap pool manager; and
in response to a non-functioning status, assigning, by the secondary heap pool manager, to the virtual machine the unused portion of the second segment to satisfy the requirement.

6. The method of claim 5, wherein the making available information associated with the first heap pool manager comprises:
making available to the secondary heap pool manager at least one of an identification of the virtual machine, an allocated address range of the second segment, and a timestamp of allocation of the second segment.

7. The method of claim 1, wherein:
the determining the amount of memory comprises determining an amount of memory in excess of the second segment needed to satisfy the requirement of the heap pool manager;
the requesting the amount of memory comprises requesting the amount of memory to satisfy the requirement of the heap pool manager; and
the assigning comprises assigning to the heap pool manager the unused portion of the defined amount of memory requested to satisfy the requirement.

8. The method of claim 1, further comprising:
determining if a requirement for memory by the virtual machine is less than the first segment; and
in response to determining that the requirement by the virtual machine is less than the first segment, assigning to the heap pool manager an amount of memory assigned to the virtual machine in excess of the requirement.

9. The method of claim 1, further comprising:
determining if a requirement for memory by the heap pool manager is less than the second segment; and
in response to determining that the requirement by the heap pool manager is less than the second segment, assigning to the computer system an amount of memory assigned to the heap pool manager in excess of the requirement by the heap pool manager.

10. A method to manage memory of a computer system comprising a virtual machine, the method comprising:
making available a first segment of a defined amount of memory to the virtual machine;
making available a second segment of the defined amount of memory to a first heap pool manager;
determining an amount of memory in excess of the first segment needed to satisfy a requirement of the virtual machine;
requesting from the first heap pool manager the amount of memory in excess of the first segment to satisfy the requirement of the virtual machine;
assigning to the virtual machine an unused portion of the second segment;
subsequent to a lack of response by the first heap pool manager to the request by the virtual machine:
making available to a secondary heap pool manager at least one of an identification of the virtual machine, an allocated address range of the second segment, and a timestamp of allocation of the second segment;
requesting from the secondary heap pool manager the amount of memory to satisfy the requirement of the virtual machine;
determining a status of the first heap pool manager; and
in response to a non-functioning status, assigning, by the secondary heap pool manager, to the virtual machine the unused portion of the second segment to satisfy the requirement of the virtual machine;
determining an amount of memory in excess of the second segment needed to satisfy a requirement of one of the first heap pool manager, and the secondary heap pool manager;
requesting from the computer system the amount of memory to satisfy the requirement of one of the first heap pool manager, and the secondary heap pool manager;
assigning to one of the first heap pool manager and the secondary heap pool manager an unused portion of the defined amount of memory to satisfy the requirement of one of the first heap pool manager, and the secondary heap pool manager;
determining if a requirement of the virtual machine is less than the first segment;
in response to determining that the requirement of the virtual machine is less than the first segment, assigning to one of the first heap pool manager, and the secondary heap pool manager an amount of memory assigned to the virtual machine in excess of the first segment;
determining if a requirement of one of the first heap pool manager, and the secondary heap pool manager is less than the second segment; and
in response to determining that the requirement of one of the first heap pool manager and the secondary heap pool manager is less than the second segment of memory, assigning to the computer system an amount of memory assigned to one of the first heap manager, and the secondary heap pool manager in excess of the second segment.

11. A program storage device readable by a computer, the device embodying a program or instructions executable by the computer to perform the method of claim 1.

12. A computer system comprising:
a defined amount of memory;
a virtual machine configured to execute programs;
a first segment of the defined amount of memory available to the virtual machine;
a heap pool manager configured to manage assignment of the defined amount of memory for the virtual machine; and
a second segment of the defined amount of memory made available to the heap pool manager;
wherein in response to a requirement of at least one of the virtual machine and the heap pool manager, at least one of the virtual machine and the heap pool manager are configured to determine an amount of memory to satisfy the requirement;
wherein at least one of the virtual machine and the heap pool manager are configured to request the amount of memory needed to satisfy the requirement; and
wherein at least one of the virtual machine and the heap pool manager are configured to assign at least one of an unused portion of the first segment, an unused portion of the second segment, and an unused portion of the defined amount of memory to satisfy the requirement.

13. The system of claim 12, wherein:
the virtual machine is one virtual machine.

14. The system of claim 12, wherein:
the virtual machine is configured to determine an amount of memory in excess of the first segment needed to satisfy the requirement of the virtual machine;
the virtual machine is configured to request from the heap pool manager the amount of memory to satisfy the requirement; and
the heap pool manager is configured to assign to the virtual machine the unused portion of the second segment to satisfy the requirement.

15. The system of claim 14, wherein the heap pool manager is a first heap pool manager, the system further comprising:
a secondary heap pool manager configured to be responsive to a request for memory by the virtual machine;
wherein subsequent to a lack of response by the first heap pool manager, the virtual machine is configured to request the amount of memory from the secondary heap pool manager;
wherein the secondary heap pool manager is configured to obtain information associated with the first heap pool manager; and
wherein the secondary heap pool manager is configured to determine a status of the first heap pool manager, and in response to a non-functioning status, to assign to the virtual machine the unused portion of the second segment to satisfy the requirement.

16. The system of claim 15, wherein:
the secondary heap pool manager is configured to obtain at least one of an identification of the virtual machine, an allocated address range of the second segment, and a timestamp of allocation of the second segment.

17. The system of claim 12, wherein:
the heap pool manager is configured to determine an amount of memory in excess of the second segment needed to satisfy the requirement of the heap pool manager;
the heap pool manager is configured to request from the computer system an amount of memory to satisfy the request of the heap pool manager; and
the heap pool manager is configured to assign the unused portion of the defined amount of memory to satisfy the requirement.

18. The system of claim 12, wherein:
the virtual machine is configured to determine if a requirement by the virtual machine is less than the first segment; and
in response to the determination that the requirement by the virtual machine is less than the first segment, at least one of the virtual machine and the heap pool manager is configured to assign to the heap pool manager an amount of memory assigned to the virtual machine in excess of the requirement.

19. The system of claim 12, wherein:
the heap pool manager is configured to determine if a requirement by the heap pool manager is less than the second segment; and
in response to the determination that the requirement by the heap pool manager is less than the second segment, the heap pool manager is configured to assign to the computer system an amount of memory assigned to the heap pool manager in excess of the requirement.
